(19) United States
(12) Patent Application Publication
(10) Pub. No.: US 2008/0310943 A1
(43) Pub. Date: Dec. 18, 2008

(54) Handling Device For Handling A Motor Vehicle Rim In A Surface Treatment Installation

(75) Inventor: Thomas Rau, Boeblingen (DE)

Correspondence Address: FACTOR & LAKE, LTD, 1327 W. WASHINGTON BLVD., SUITE 5G/H, CHICAGO, IL, 60607, US

(73) Assignee: EISENMANN ANALAGENBAU GMBH & CO. KG, BOEBLINGEN (DE)

(21) Appl. No.: 11/915,927

(22) PCT Filed: May 20, 2006
(86) PCT No.: PCT/EP2006/004794

§ 371 Date: May 29, 2008

(30) Foreign Application Priority Data
Jun. 2, 2005 (DE) 10 2005 025 757.7

(51) Int. Cl. B60B 29/00

(52) U.S. Cl. 414/426

(57) ABSTRACT

A handling device for handling a motor vehicle rim (11) in an installation for its surface treatment has at least one gripping arm (12) which can be inserted into a hub (26) of the rim (11) and carries at least one pressure element which can be pressed against an inner surface (28) of the hub (26). According to the invention, the at least one pressure element (18) is designed as a cutting edge or as a pointed peg.

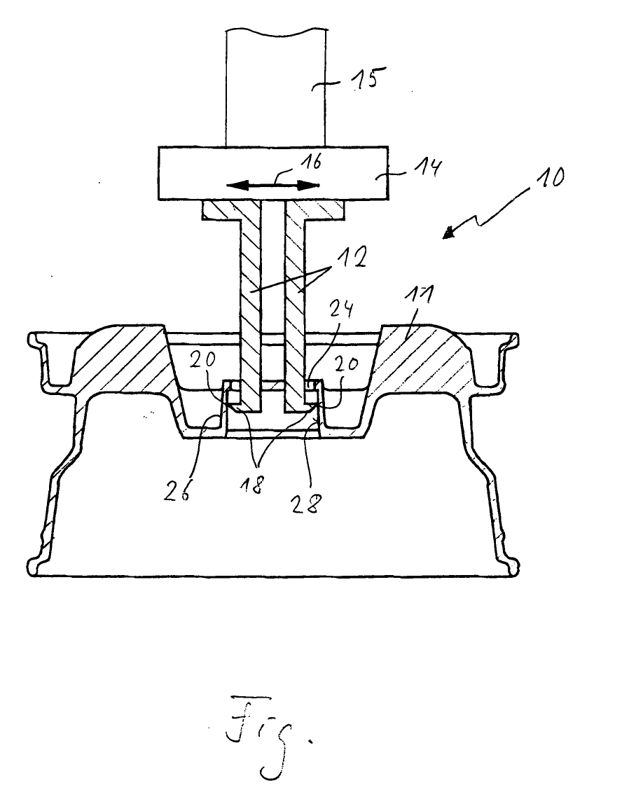

The invention concerns a handling device for handling a motor vehicle rim in an installation for its surface treatment, with at least one gripping arm which can be inserted into a hub of the rim, and which carries at least one pressure element which can be pressed against an inner surface of the hub.

Such handling devices are known from use in the prior art.

In general, light metal rims are coated in a surface treatment installation with a powder or another coating material. The coating is then sintered in a baking oven.

At the changeover between the coating station and the baking oven, it is necessary to transfer the coated light metal rims from a coating conveyor to a baking conveyor using a handling device.

Known handling devices for this transfer process have two or more gripping arms, which can be inserted into a hub of the light metal rim and moved radially outward by force. The gripping arms are provided at one end with pressure elements in the form of plastic or metal strips, which come into plane contact with the inner surface of the hub when the rim is seized. Via the strips, a non-positive contact between the gripping arms and the hub is achieved, so that the gripping arms, which are connected to a robot arm, can carry the rim with them.

Since the handling device must position the rims very precisely, in the case of the known handling device relatively high pressures are required to generate the required holding forces. However, the result of the high pressures can be that on the inner surface of the hub of the light metal rim, marks consisting of partly sintered- out coating material appear. This material can no longer be completely removed in subsequent hub cleaning by brushing or similar treatment. Since very high requirements are set for the surface properties of light metal rims, such marks on the hub can result in expensive reworking on the finished product, or even rejection of the affected rim.

It is therefore the object of the invention to improve a handling device of the above-mentioned type so that the risk of damage to the surface of the rim by the handling device is reduced.

In the case of a handling device of the above-mentioned type, this object is achieved by the at least one pressure element being in the form of a blade or pointed mandrel.

When the blades or mandrels are pressed onto the inner surface of the hub, they cut slightly into the surface of the material of which the rim consists, because of the pressure. Tests have shown that in this way, with the same holding forces, the pressure can be considerably reduced compared with known handling devices. Since there is only linear or point contact between the pressure elements according to the invention and the inner surface of the hub, when pressure is applied the deposited powder coating or another coating material cannot sinter on to more than a nominal extent, and cause enduring marks in this way.

To press the pressure elements according to the invention onto the inner surface of the hub, for instance multiple gripping arms, each of which carries one or more pressure elements, can be provided. When they are pressed on, the gripping arms move radially outward, and carry the pressure elements with them.

Alternatively, only a single gripping arm, which carries a device from which at least two pressure elements can be moved radially outward, can be provided. The arrangement of the pressure elements must be chosen so that the forces are transmitted as evenly as possible between the rim and the gripping arm.

In an advantageous version of the invention, the at least one pressure element is a blade with a cutting edge in the form of an arc of a circle. In this way, in the case of the rims which are usually used, and of which the hub inner surface runs conically, an approximately linear contact between the blade and the rim is achieved. In the case of multiple blades, the circular arcs can be concentric, and have the same circle radii. In this way, the blades form a doubly or multiply interrupted ring, which has a small diameter when it is introduced, extends radially into the hub of the rim to grip it, and finally comes into contact with the inner surface of the hub, exactly or at least approximately linearly, along the cutting edges. The cutting edges are only in a movement position corresponding to the radius of curvature of the circular arcs, on a geometrical circumference. If an exactly linear contact between the cutting edges and the inner surface of the hub is desired, this movement position must be the final position, in which the blades are pressed onto the inner surface of the hub.

A specially symmetrical distribution of the pressures is achieved if the handling device has n pressure elements, which are arranged with n-fold symmetry, where n=2, 3, 4, . . . , and preferably equals 3.

If mandrels are used, a device with which the mandrels can be moved in and out in a radial direction can be arranged on at least one gripping arm. For instance, three mandrels, which act on the inner surface of the hub offset by 120° from each other, can be provided.

In another advantageous version of the invention, the blades are beveled. This allows even smaller pressures, and further reduces the risk of damage to the coating material which is deposited on the rim.

An embodiment of the invention is described below on the basis of the only figure, in which essential parts of a handling device 10 according to the invention for handling a light metal rim 11 are shown in an axial cross-section. The handling device 10 is part of an installation in which the surfaces of light metal rims are treated. The handling device 10 has the task, for instance, of transferring the light metal rim 11 from a coating conveyor to a baking conveyor.

The handling device 10 has two gripping arms 12, which can be moved towards each other using a drive, which is indicated at 14, in a direction which is indicated by an arrow 16. The drive 14 is connected to a robot arm, which is indicated in the figure at 15, of the handling device 10.

On the gripping arms 12, at the ends opposite the drive 14, pressure elements 18 of blade type are formed. The pressure elements 18 have a periphery in the shape of a segment of a circle in a perpendicular plane to the longitudinal extent of the gripping arms 12. Along the curved side in the form of a circular arc, the pressure elements 18 are slanted so that cutting edges 20, which for the purpose of a greater cutting effect can be beveled, result there. The pressure elements 18 therefore preferably consist of a high-quality steel.

The handling device 10 according to the invention and shown in the figure functions as follows:

To be able to grip the light metal rim 11, the gripping arms 12 must first be moved radially towards each other using the drive 14. The gripping arms 12 are also moved, using the robot arm 15, relative to the light metal rim 11, so that the two gripping arms 12, with the pressure elements 18 which are formed on them, can be inserted through a front opening 24 of a hub 26 of the light metal rim 11. A controller of the robot arm 15 now ensures that the pressure elements 18 are positioned in a defined longitudinal position in the slightly conical hub 26.

Now, using the drive 14, the gripping arms 12 are moved radially apart from each other in the direction indicated by the arrow 16. The pressure elements 18 move towards the inner surface 28 of the hub 26. Finally, the cutting edges 20 of the pressure elements 18 come into contact with the hub 26, and cut slightly into its inner surface 28. The longitudinal position of the gripping arms 12 in the hub 26 is adapted to the radius of curvature of the cutting edges 20 and the shape of the inner surface 28 of the hub 26 in such a way that the cutting edges 20 touch the inner surface 28 of the hub 26 as evenly as possible along their whole length. Because of the cutting in, even with relatively small pressure of the gripping arms 12 on the inner surface 28 of the hub 26, large holding forces, which are necessary for swinging the robot arm 15 precisely to the desired position within the surface treatment installation, can be generated.

What is also achieved by the linear contact between the gripping arms 12 and the hub 26 is that a powder coating or similar, which is deposited on the light metal rim 11, is practically not damaged by the handling device 10, as would be the case with an area contact between the pressure elements 18 and the inner surface 28 of the hub 26.

1. A handling device for handling a motor vehicle rim in an installation for its surface treatment, with at least one gripping arm which can be inserted into a hub of the rim, and which carries at least one pressure element which can be pressed against an inner surface of the hub, wherein the at least one pressure element is in the form of a blade or pointed mandrel.

2. The handling device of claim 1, wherein the at least one pressure element is a beveled blade.

3. The handling device of according to claim 1, wherein the at least one pressure element is a blade with a cutting edge in the form of a circular arc.

4. The handling device of claim 1, wherein the handling device has n pressure elements, which are arranged with n-fold symmetry, where n=2, 3, 4, . . .

5. The handling device of claim 1, wherein the pressure elements can be pressed onto the inner surface of the hub by force.

6. The handling device of claim 2, wherein the at least one pressure element is a blade with a cutting edge in the form of a circular arc.

7. The handling device of claim 6, wherein the handling device has n pressure elements, which are arranged with n-fold symmetry, where n=2, 3, 4, . . .

8. The handling device of claim 3, wherein the handling device has n pressure elements, which are arranged with n-fold symmetry, where n=2, 3, 4, . . .

9. The handling device of claim 2, wherein the handling device has n pressure elements, which are arranged with n-fold symmetry, where n=2, 3, 4, . . .

10. The handling device of claim 2, wherein the pressure elements can be pressed onto the inner surface of the hub by force.

11. The handling device of claim 3, wherein the pressure elements can be pressed onto the inner surface of the hub by force.

12. The handling device of claim 6, wherein the pressure elements can be pressed onto the inner surface of the hub by force.

13. The handling device of claim 4, wherein the pressure elements can be pressed onto the inner surface of the hub by force.

14. The handling device of claim 9, wherein the pressure elements can be pressed onto the inner surface of the hub by force.

15. The handling device of claim 8, wherein the pressure elements can be pressed onto the inner surface of the hub by force.

16. The handling device of claim 7, wherein the pressure elements can be pressed onto the inner surface of the hub by force.
